(19) United States
(12) Patent Application Publication
(10) Pub. No.: US 2022/0361108 A1
(43) Pub. Date: Nov. 10, 2022

(54) METHOD FOR DETERMINING SIDELINK RESOURCE

(71) Applicant: Samsung Electronics Co., Ltd., Suwon-si (KR)

(72) Inventors: Miao ZHOU, Beijing (CN); Yi WANG, Beijing (CN); Feifei SUN, Beijing (CN)

(21) Appl. No.: 17/738,414

(22) Filed: May 6, 2022

(30) Foreign Application Priority Data
May 8, 2021 (CN) 202110502314.1
Aug. 4, 2021 (CN) 202110893371.7

(51) Int. Cl. H04W 52/02; H04W 74/08; H04W 72/02; H04W 72/04; H04W 72/12; H04L 1/18

(52) U.S. Cl. CPC H04W 52/0235; H04W 52/0232; H04W 74/0808; H04W 74/0866; H04W 72/02; H04W 72/0446; H04W 72/1289; H04L 1/1812

(57) ABSTRACT

A method for determining sidelink resource is provided. The method includes enabling a power saving mechanism by a first node, and determining a resource for sidelink transmission based on the power saving mechanism.

### CROSS-REFERENCE TO RELATED APPLICATION(S)

This application is based on and claims priority under 35 U.S.C. § 119(a) of a Chinese patent application number 202110502314.1, filed on May 8, 2021, in the China National Intellectual Property Administration, and of a Chinese patent application number 202110893371.7, filed on Aug. 4, 2021, in the China National Intellectual Property Administration, the disclosure of each of which is incorporated by reference herein in its entirety.

### BACKGROUND

### 1 Field

The present disclosure relates to the field of wireless communication technology, and more specifically, to a method for transmitting sidelink (SL) data and corresponding sidelink feedback messages in the sidelink communication in the fifth-generation new radio access technology 5^{th} generation new radio (5G NR) system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The aspects and advantages of the embodiments of the disclosure will be partially described in the following description, or can be learned from the description, or can be learned through the implementation of the embodiments.

Aspects of the disclosure are to address at least the above-mentioned problems and/or disadvantages and to provide at least the advantages described below. Accordingly, an aspect of the disclosure is to provide a method for performing sensing on a part of resource of sidelink system when a power saving mechanism is used in the sidelink communication system. For the purpose of power saving, the method is further optimized based on the sensing of the traditional communication system, such that the user equipment (UE) can perform sensing on re-evaluation, pre-emption mechanism when using partial sensing, the UE can also select a resource set that is more suitable as a candidate resource based on the current sensing result when it is triggered to perform resource selection, to realize the purpose of improving the current performance of transmission and reduce the system power consumption.

Another aspect of the disclosure is to provide a method for interacting with a base station based on the discontinuous reception (DRX) mechanism in the sidelink communication system. The method is optimized based on the traditional discontinuous transmission (DTX) mechanism, such that the DRX mechanism between the UE and the base station can be used for uplink and downlink signal/channel, for example, downlink control information (DCI) for scheduling the sidelink transmission and physical uplink control channel (PUCCH) for reporting hybrid automatic repeat request-acknowledgement (HARQ-ACK) feedback and uplink control information (UCI).

According to one aspect of the present disclosure, a method for determining sidelink resource is provided, comprising, enabling a power saving mechanism by a first node; and determining a resource for sidelink transmission based on the power saving mechanism.

Additional aspects will be set forth in part in the description which follows and, in part, will be apparent from the description, or may be learned by practice of the presented embodiments.

In accordance with an aspect of the disclosure, a method for interacting with a second node in a sidelink communication system is provided. The method includes, obtaining a discontinuous reception DRX configuration corresponding to the sidelink communication by the first node; and communicating with the second node based on the DRX configuration corresponding to the sidelink communication.

Other, aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network 100 according to an embodiment of the disclosure;

FIG. 2A illustrates an example wireless transmission and reception path according to an embodiment of the disclosure;

FIG. 2B illustrates an example wireless transmission and reception path according to an embodiment of the disclosure;

FIG. 3A illustrates an example UE according to an embodiment of the disclosure;

FIG. 3B illustrates an example gNB according to an embodiment of the disclosure;

FIG. 4 is a flowchart showing a method according to an embodiment of the disclosure;

FIG. 5 schematically illustrates embodiment 1 according to an embodiment of the disclosure;

FIG. 6 schematically illustrates embodiment 2 according to an embodiment of the disclosure; and

FIG. 7 schematically illustrates embodiment 3 according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although terms including ordinal numbers such as “first” and “second” are used to describe various elements (for example, components, steps, etc.), these elements are not limited by these terms. These terms are only used to distinguish one element from another. Therefore, these terms may be used interchangeably without departing from the scope of the present disclosure. For example, the first element may be referred to as the second element, and similarly, the second element may also be referred to as the first element. In addition, as used herein, the terms “/”, “or”, “and/or” are intended to include any and all combinations of one or more related items.

By referring to the following detailed description of the various embodiments and the accompanying drawings in the specification, the aspects and features of the disclosure and the implementation thereof can be understood more clearly. However, the disclosure may be embodied in many different forms, and should not be construed as being limited to the various embodiments set forth herein. Rather, these embodiments are provided to make the disclosure full and complete, and to fully convey the principles and concepts of the disclosure to those skilled in the art. Therefore, those of ordinary skill in the art should recognize that various modifications, adjustments, combinations and substitutions can be made to the various embodiments described in the disclosure without departing from the spirit and scope of the present disclosure. Moreover, these modifications, adjustments, combinations and substitutions should also be considered to be included in the scope of protection of this disclosure as defined by the claims.

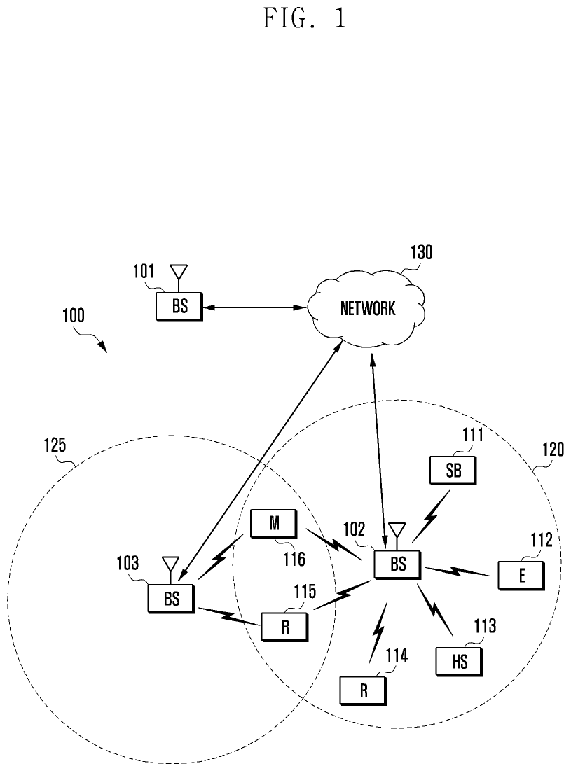

FIG. 1 illustrates an example wireless network 100 according to an embodiment of the disclosure.

The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UEs) within a coverage area 120 of gNB 102. The first plurality of UEs include a UE 111, which may be located in a small business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

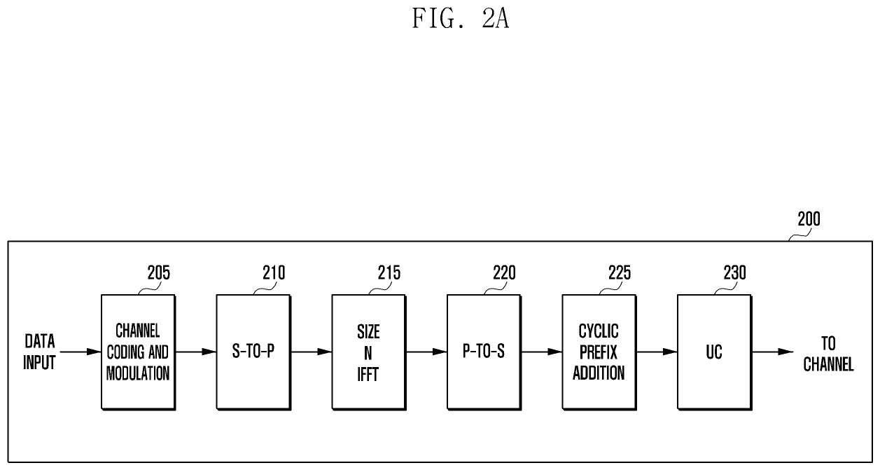

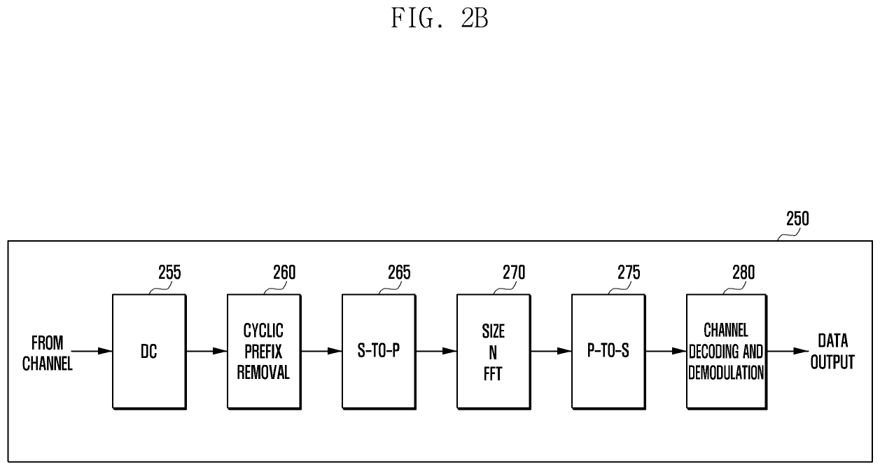

FIGS. 2A and 2B illustrate example wireless transmission and reception paths according to various embodiments of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete fourier transform (DFT) and inverse discrete fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

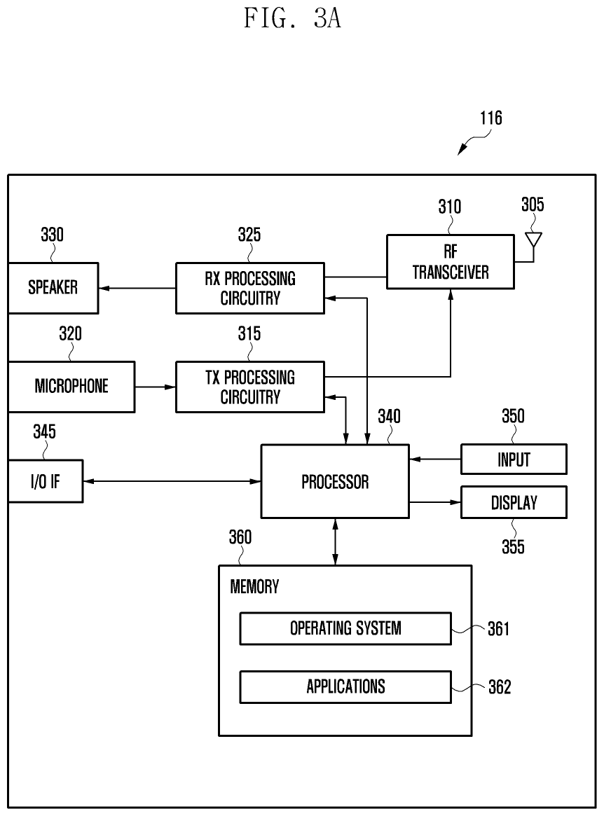

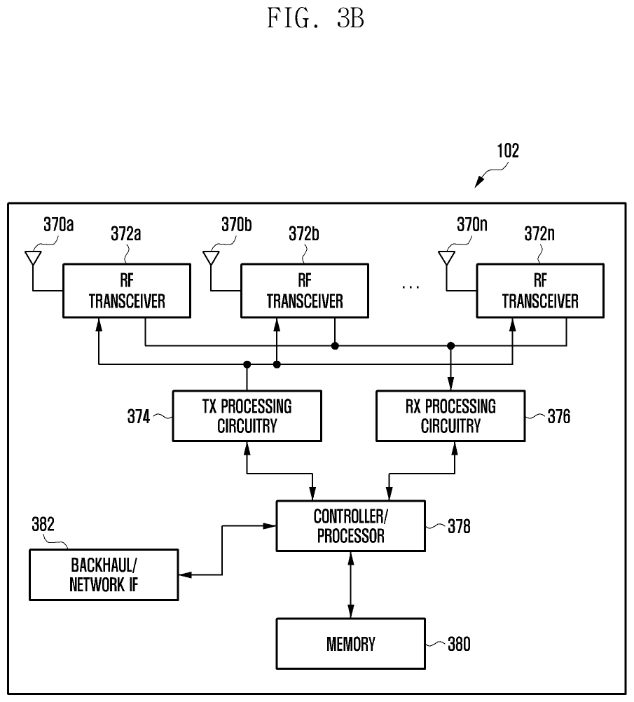

FIG. 3A illustrates an example UE 116 according to an embodiment of the disclosure.

The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a, 370b, . . . 370n, a plurality of RF transceivers 372a, 372b, . . . 372n, a transmission (TX) processing circuit 374, and a reception (RX) processing circuit 376. In certain embodiments, one or more of the plurality of antennas 370a, 370b . . . 370n include a 2D antenna array. gNB 102 also includes a controller/processor 378, a memory 380, and a backhaul or network interface 382.

RF transceivers 372a, 372b, . . . 372n receive an incoming RF signal from antennas 370a, 370b, . . . 370n, such as a signal transmitted by UEs or other gNBs. RF transceivers 372a, 372b, . . . 372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a, 372b, . . . 372n receive the outgoing processed baseband or IF signal from TX processing circuit 374 and up-convert the baseband or IF signal into an RF signal transmitted via antennas 370a, 370b, . . . 370n.

The controller/processor 378 can include one or more processors or other processing devices that control the overall operation of gNB 102. For example, the controller/processor 378 can control the reception of forward channel signals and the transmission of backward channel signals through the RF transceivers 372a, 372b, . . . 372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a, 372b, . . . 372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In long term evolution (LTE) technology, the sidelink communication includes two main mechanisms: device-to-device (D2D) direct communication and Vehicle to Vehicle/Infrastructure/Pedestrian/Network (collectively referred to as V2X). V2X is designed on the basis of D2D technology. It is superior to D2D in terms of data rate, latency, reliability, link capacity, etc., and is the most representative sidelink communication technology in LTE technology. In the 5G system, the sidelink communication currently mainly includes vehicle-to-outside (V2X) communication.

NR V2X system defines several sidelink physical channels, including physical sidelink control channel (PSCCH), physical sidelink shared channel (PSSCH) and physical sidelink feedback channel (PSFCH). PSSCH is used to carry the data, PSCCH is used to carry sidelink control information (SCI), the SCI indicates the time-frequency domain resource position of the associated PSSCH transmission, modulation and coding mode, receiving target ID for PSSCH and other information, and PSFCH is used to carry HARQ-ACK information corresponding to the data.

In NR V2X system, at present, the time slot in 5G system is used as the minimum unit of time domain resource allocation, and sub-channel is defined as the minimum unit of frequency domain resource allocation. One sub-channel is configured as several RBs in frequency domain, and one sub-channel may include resource corresponding to at least one of PSCCH, PSSCH, and PSFCH.

From the perspective of resource allocation, 5G sidelink communication system includes two modes: a resource allocation mode based on base station scheduling and a resource allocation mode independently selected by UE. In 5G V2X system, the resource allocation mode based on base station scheduling and the resource allocation mode independently selected by UE are referred to as mode 1 and mode 2 respectively.

For mode 1, the method for the base station to schedule resource for the sidelink UE is to transmit a sidelink grant to the sidelink UE, and several or periodic sidelink resources used for the sidelink UE are indicated in the sidelink grant. The sidelink grant includes dynamic grant and configured grant, wherein the dynamic grant is indicated by DCI, the configured grant further includes the configured grant of type 1 and type 2, the configured grant of type 1 is indicated by RRC signaling, and the configured grant of type 2 is indicated by RRC signaling and activated/deactivated by DCI.

For mode 2, the method for the sidelink UE to independently select resource is that the UE always keeps monitoring and buffering of the sidelink resource pool, and determines one channel sensing time window and one resource selection time window according to the expected time range of transmitting the sidelink transmission before the sidelink transmission needs to be sent, and performs channel sensing in the channel sensing time window, excludes the sidelink resource that has been reserved by other sidelink UEs in the resource selection time window according to the result of channel sensing, and randomly selects the resource for the sidelink transmission from the sidelink resources which are not excluded in the resource selection time window.

In the traditional communication system, since the data flow of the packet is usually bursty, there is data transmission for a period of time, but there is no data transmission for a following longer period of time. Therefore, to reduce power consumption, discontinuous reception (DRX) technology is introduced to the traditional communication system, such that the UE can stop receiving physical downlink control channel (PDCCH) in the period of time when there is no data transmission, thereby the power consumption is reduced and the battery life is improved. The fundamental mechanism of DRX technology is that the UE in connected state is configured with a DRX period, a period typically consists of on-duration and off-duration (also called opportunity for DRX), the UE monitors and detects PDCCH blindly during on-duration and does not receive PDCCH during off-duration to reduce power consumption, the UE may further enter the dormant period and close the receive chain (Rx chain).

Currently, the UE performs channel sensing based on its buffered sidelink transmissions received on all resources in the sidelink resource pool. However, the premise of this method is that the UE has the requirement to receive sidelink services and is not sure at what time point it will receive the sidelink transmission sent to it. Therefore, it is necessary to continuously monitor each time slot in the sidelink resource pool, receive and buffer all possible sidelink transmissions. Since the UE will not skip any monitoring on a sidelink time slot (except for cases where it cannot be monitored due to limitations in UE capabilities such as half duplex/receiving downlink transmissions, which are not in the scope of skip monitoring), resulting in high power consumption for monitoring.

If the above premise cannot be established for a specific type of V2X UE, for example, some Pedestrian UE (P-UE) and infrastructure UE (I-UE) may not have the requirement to receive sidelink services but only have the requirement to transmit sidelink services, the sidelink resource can be monitored only for the purpose of channel sensing, so as to reduce the range of the UE to monitor the sidelink resource and reduce power consumption.

The current UE is mainly vehicle UE (V-UE), which is relatively insensitive to power consumption, so it can run smoothly. However, in order to expand the market scope and improve the system performance, V2X technology needs to be applied to more types of UEs, such as pedestrian UE (P-UE). Therefore, it is beneficial to enhance channel sensing technology for the purpose of reducing power consumption.

Some specific channel sensing technologies, such as some sensing technologies and similar mechanisms in LTE V2X system, have certain limitations in their applicable scenarios. For example, LTE V2X partial sensing is suitable for periodic traffic of transmitter UE, while for burst services of transmitter UE, since it is difficult to expect the time point of burst services, some sensing technologies may be difficult to determine the corresponding sensing window before the burst service arrives, so it is difficult to implement. Therefore, the sidelink communication system may support a variety of resource allocation schemes based on channel sensing and/or not based on channel sensing, and apply different schemes in different scenarios.

In addition, some sidelink services also have characteristics similar to those in the traditional communication mechanism, that is, after transmitting data for a period of time, there will be no continuous data transmission for a longer period of time. Therefore, the power consumption caused by the sidelink communication can be further reduced by introducing the DRX mechanism.

The ˜˜embodiments of the disclosure are further described below with reference to the accompanying drawings.

The text and the accompanying drawings are provided only as examples to help readers understand the present disclosure. They are not intended and should not be construed as limiting the scope of the disclosure in any way. Although some embodiments and examples have been provided, based on the contents disclosed herein, it is obvious to those skilled in the art that the embodiments and examples shown can be modified without departing from the scope of the present disclosure.

The time slot in the embodiment of the disclosure can be either a subframe or time slot in the physical sense or a subframe or time slot in the logical sense. Specifically, the subframe or time slot in the logical sense is the subframe or time slot corresponding to the resource pool of sidelink communication. For example, in V2X system, the resource pool is defined by a repeated bitmap, which is mapped to a specific set of time slots. The specific set of time slots can be all time slots or all other time slots except some specific time slots (such as the time slot for transmitting MIB/SIB). The time slot indicated as “1” in the bitmap can be used for V2X transmission and belongs to the time slot corresponding to V2X resource pool; the time slot indicated as “0” cannot be used for V2X transmission and does not belong to the time slot corresponding to the V2X resource pool.

The following is a typical application scenario to illustrate the difference between the physical or logical subframes or time slots: when calculating the time domain gap between two specific channels/messages (such as PSSCH carrying sidelink data and PSFCH carrying corresponding feedback information), it is assumed that the gap is N time slots. If the physical subframe or time slot is calculated, the N time slots correspond to the absolute time length of N*x milliseconds in the time domain, x is the time length of the physical time slot (subframe) under the numerology of the scenario in millisecond; otherwise, if the subframe or time slot in the logical sense is calculated, take the sidelink resource pool defined by the bitmap as an example, the gap of the N time slots corresponds to the N time slots indicated as “1” in the bitmap, and the absolute time length of the gap changes with the specific configuration of the sidelink communication resource pool without a fixed value.

Further, the time slot in the embodiment of the present disclosure can be a complete time slot or several symbols corresponding to the sidelink communication in one time slot. For example, when the sidelink communication is configured to be performed on the X1-X2 symbols of each time slot, the time slot in the following embodiment is the X1-X2 symbols in the time slot in this scenario; alternatively, when the sidelink communication is configured as mini slot transmission, the time slot in the following embodiment is a mini slot defined or configured in the sidelink system rather than a time slot in the NR system; alternatively, when the sidelink communication is configured as symbol level transmission, the time slot in the following embodiment may be replaced with a symbol, or may be replaced with N symbols of time domain granularity as symbol level transmission.

In the embodiment of this disclosure, the information configured by the base station, indicated by the signaling, configured by the higher layer, and pre-configured includes a group of configuration information; it also includes multiple groups of configuration information, and the UE selects a group of configuration information for use according to predefined conditions; it also includes a group of configuration information including multiple subsets, from which UE selects a subset for use according to predefined conditions.

Some of the technical solutions provided in the embodiments of the disclosure are specifically described based on V2X system, but the application scenario thereof should not be limited to V2X system in the sidelink communication, but can also be applied to other sidelink transmission systems. For example, the design based on the V2X subchannel in the following embodiments can also be used for D2D subchannel or other sidelink transmission subchannel. The V2X resource pool in the following embodiments can also be replaced with a D2D resource pool in other sidelink transmission systems, such as D2D.

In the embodiment of the disclosure, when the sidelink communication system is V2X system, the terminal or UE can be various types of terminals or UEs such as Vehicle, Infrastructure, Pedestrian, etc.

In order to make the objectives, technical solutions, and advantages of the present disclosure clearer, the implementation of the present disclosure will be further described in detail below in conjunction with the accompanying drawings.

In the embodiment of the present disclosure, lower than the threshold can also be replaced by at least one of higher than the threshold, lower than or equal to the threshold and higher than or equal to the threshold; higher than (exceeding) the threshold may also be replaced by at least one of lower than the threshold, lower than or equal to the threshold, and higher than or equal to the threshold. Lower than or equal to may also be replaced by at least one of lower than, higher than, higher than or equal to, or equal to; higher than or equal to may also be replaced with at least one of lower than, higher than, lower than or equal to, or equal to.

In the traditional communication system, since the DRX system mainly corresponds to PDCCH reception, it is called discontinuous reception. In the sidelink communication system, DRX mechanism can be used for transmission and reception of the UE, correspondingly, in the embodiment of the present disclosure, discontinuous transmission (DTX) and discontinuous reception (DRX) can be replaced with each other, and the protection scope should not be affected by the difference in names.

The base station in the present specification can be replaced by other nodes, such as sidelink nodes, a specific example is the infrastructure UE in the sidelink system.

In the present specification, the active period/inactive period of the DRX configuration and the measured measurement window may include physical subframes and/or logical subframes, wherein the logical subframes include subframes configured to the sidelink resource pool.

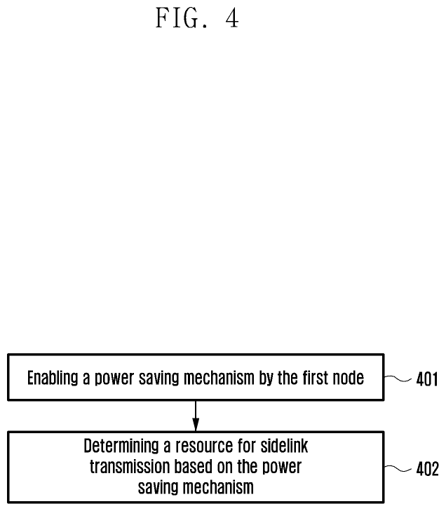

FIG. 4 is a flowchart showing a method according to an embodiment of the disclosure.

Step 401: enabling a power saving mechanism by a first node; Step 402: determining a resource for sidelink transmission based on the power saving mechanism, wherein the first node can be user equipment (UE). Taking the UE as an example, the UE obtains the configuration of the power saving mechanism, and determines the resource for sidelink transmission according to the configuration, including obtaining from at least one of the base station/other UE/its own higher layer, wherein obtained from its own higher layer can be pre-configured information.

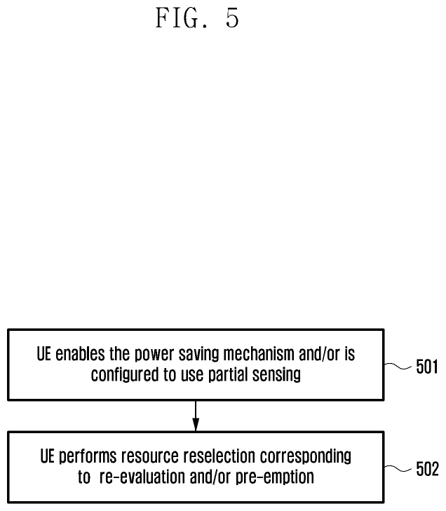

FIG. 5 schematically illustrates embodiment 1 according to an embodiment of the disclosure.

In this embodiment, in the sidelink communication system, feasible resource allocation schemes include full sensing, partial sensing, random selection, re-evaluation, pre-emption, etc. Wherein, the full sensing mainly means that UE receives and buffers all resources in the configured sidelink resources. The advantage of this method is that the sensing information collected is the most sufficient. For any sidelink transmission, the UE assumes that its corresponding sensing window has been buffered by the UE, and based on full sensing, the UE can detect as many potential conflicts as possible with other sidelink UEs; however, the power consumption caused by full sensing is high, so it is more suitable for UEs that are not sensitive to power consumption, such as vehicle nodes whose communication module has on-board power supply.

The partial sensing mainly means that the UE receives and buffers only part of the resources in the configured sidelink resources; generally, the part of the resources corresponds to the sensing window of all transmissions initiated by the UE or the sensing window of all transmissions initiated by the UE belongs to a subset of this part of the resource. The advantage of this method is that the power consumption corresponding to receiving and buffering by UE is lower, which helps UE save energy. However, compared with full sensing, if the partial sensing pursues lower power consumption, it needs to reduce the scope of detecting potential conflicts. Therefore, it is likely to sacrifice part of the performance of avoiding conflicts. In the protocol, the full sensing and the partial sensing can correspond to different sensing window calculation methods.

Further, the partial sensing/full sensing may also include periodic sensing (window) and/or continuous sensing (window). The periodic sensing mainly refers to at least one resource in the resource selection window, and its corresponding sensing window includes periodic blocks of resources. Continuous sensing mainly refers to the resource selection window or at least one resource in the resource selection window, and the corresponding sensing window includes at least one continuous time window. The periodic sensing and/or the continuous sensing may be used in combination, for example, one resource selection window or at least one resource in the resource selection window corresponds to a periodic sensing window and a continuous sensing window; or can be used separately.

Compared with the resource allocation schemes based on sensing, the random selection mainly refers to a resource allocation scheme that is not based on sensing information (or can be partially based on sensing information). When the UE uses resource allocation based on the random selection, it usually determines the set of the candidate resources based on the related parameters such as load size of the data, arrival time, latency requirement, as well as the characteristics such as UE capability, and randomly selects the resource actually used for transmission in the set of the candidate resources. This process generally does not involve the exclusion of the candidate resources based on channel sensing, or it can also involve the exclusion of the candidate resources based on channel sensing, but does not introduce a dedicated sensing window. The advantage of this method is that it does not introduce the power consumption caused by channel sensing, and because this method does not require sufficient sensing results, it can be used in any scenario. In addition, due to skipping the sensing process, the latency of initial transmission may be lower when using this method; however, compared with the transmission based on sensing, since the random selection method cannot avoid potential conflicts with other UEs, the performance of its single transmission may be worse than that of the transmission based on sensing, resulting in performance degradation or leads to more retransmissions.

Re-evaluation and pre-emption occur after the UE selects the resource for the sidelink transmission. Re-evaluation mainly refers to when the UE has selected a resource for the sidelink transmission, and has not transmitted on this resource, and has not reserved the resource in previous transmissions, it decides to give up using the resource because it detects that there is a conflict on the resource. At this time, the UE can reselect another resource for the sidelink transmission. Pre-emption is similar to re-evaluation, but it mainly means that after the UE has reserved resource for the sidelink transmission by means of signaling indication, it decides to give up using the resource because it detects that there is a conflict on the resource. At this time, the UE can reselect another resource for sidelink transmission.

During the re-evaluation or pre-emption process, if the UE detects a conflict and decides to abandon the use of the selected resources, the UE may re-select resources. As shown by FIG. 5, the present embodiment provides a method for UE to perform resource reselection (502) corresponding to the re-evaluation or pre-emption after the power saving is enabled and/or the UE is configured to use partial sensing (501).

In this embodiment, the first UE serves as a transmitter of the sidelink data and the second UE serves as a receiver of the sidelink data. In this specification, the second UE may also be replaced by one or more communication nodes, which can be a UE or a base station.

In the communication mode 2 of the sidelink system, if the first UE is configured to use sensing and/or partial sensing, and/or the resource pool is configured to enable sensing and/or partial sensing, when the first UE transmits sidelink signal/channel, it may need to perform channel sensing for the transmission and determine the resource for transmitting the sidelink signal/channel based on the sensing result. Wherein the sidelink signal/channel includes PSSCH and/or PSCCH. It should be noted that the time of the sensing behavior may be before or after the time when the first UE determines that it needs to transmit a sidelink signal/channel or is triggered by a higher layer to perform resource selection, that is the first UE may perform sensing in advance for potential transmission in the future that has not yet arrived, and/or the first UE may be triggered by a higher layer to perform resource selection and then perform sensing. To be distinguished from re-evaluation and pre-emption, the first UE triggered by a higher layer to perform resource selection can be referred as initial resource selection in this embodiment. To perform the above sensing, the first UE needs to determine a sensing window corresponding to the initial resource selection.

In the communication mode 2 of the sidelink system, if the first UE is configured to use re-evaluation and/or pre-emption, and/or the resource pool is configured to enable re-evaluation and/or pre-emption, when the first UE transmits sidelink signal/channel, the first UE needs to perform re-evaluation and/or pre-emption detection after determining the transmission resources and before actual transmission, and may need to reselect transmission resources after re-evaluation and/or pre-emption detection; therefore, the first UE may also perform channel sensing for the re-evaluation and/or pre-emption detection and/or the reselection of transmission resources, and determine whether a conflict is detected, whether the selected resource needs to be released and resource reselection is triggered, and the resource for transmitting sidelink signal/channel is reselected based on the sensing results. To be distinguished from the resource determined when the first UE is triggered by the higher layer to perform resource selection, the resource reselected for transmitting sidelink signal/channel triggered based on the conflict detected by the re-evaluation and/or pre-emption can be referred as resource reselection for short in this embodiment.

In this embodiment, the behaviors associated with resource reselection (such as certain behavior corresponding to the resource reselection) can be replaced by the behaviors associated with re-evaluation and/or pre-emption and will not be repeated.

In this embodiment, the resource reselected for transmitting signals/channels triggered based on the conflict detected by the re-evaluation and/or pre-emption can also be replaced by the resource reselected for transmitting signals/channels triggered based on the coordination information between UEs. At this time, the behaviors associated with resource reselection can also be replaced by the behaviors associated with the coordination information between UEs.

In some implementations, when the first UE needs to transmit sidelink signal/channel to the second UE, it determines the resource for transmitting the sidelink signal/channel by itself. When at least one of the following is satisfied, the first UE determines a sensing window corresponding to the resource reselection and performs sensing on the sensing window:

the first UE is configured to use (or configured with) re-evaluation and/or pre-emption;

the resource pool for transmitting sidelink signal/channel is configured to enable re-evaluation and/or pre-emption;

the first UE is configured to use (or configured with) partial sensing;

the first UE is configured to enable the re-evaluation and/or pre-emption corresponding to the sensing;

the priority corresponding to the sidelink signal/channel is within a specific threshold range;

the latency corresponding to the sidelink signal/channel is within a specific threshold range; wherein the latency can be determined by remaining packet delay budget (PDB);

the battery remaining of the first UE is within a specific threshold range;

the congestion level of the resource pool is within a specific threshold range; wherein the congestion level can be determined by channel busy ratio (CBR);

whether the hybrid automatic repeat request (HARQ) is enabled when the first UE transmits the sidelink signal/channel;

the HARQ error rate of the first UE is within a specific threshold range; wherein the HARQ error rate can be the HARQ error rate corresponding to the data carried by the sidelink signal/channel; wherein the HARQ error rate includes the probability of HARQ transmission failure within a period of time, and/or the number of HARQ (continuous) transmission failure; the HARQ transmission may be HARQ transmission corresponding to the data carried by the sidelink signal/channel that the first UE needs to transmit, or any HARQ-based transmission;

the number of retransmissions corresponding to the data carried by sidelink signal/channel that the first UE needs to transmit is within a specific threshold range.

The main advantage of the method is that the power consumption caused by sensing is the main component of the power consumption of sidelink transmission, but it can significantly improve the reliability of transmission, so whether to enable sensing can be regarded as a trade-off between power consumption and reliability. For re-evaluation and/or pre-emption, since the resource position for performing re-evaluation and/or pre-emption is determined based on the initial resource selection, its resource position has a certain degree of uncertainty, the UE determines the corresponding sensing window in advance having higher complexity and risk of waste. Therefore, enabling (partial) sensing only for re-evaluation and/or pre-emption of partial transmission that satisfies specific conditions (such as high-priority transmission or delay-sensitive transmission) can effectively save system power consumption and ensure the performance of the partial transmission at the same time; for other transmissions that do not satisfy specific conditions, (partial) sensing cannot be enabled for them and HARQ retransmission is used to compensate for their reliability when a single transmission fails.

The above conditions can be understood as being used to define which conditions are satisfied, the UE can enable (partial) sensing for resource reselection (or for re-evaluation and/or pre-emption). Further, the above conditions can not only be used as conditions for whether to enable partial sensing, if the UE is configured with multiple resource allocation schemes, they can also be used as conditions for whether to enable any one/multiple resource allocation schemes. In some implementations, for any specific resource allocation scheme, when at least one of the following is satisfied, the first UE determines whether to use (or not to use) the resource allocation scheme for resource reselection:

the first UE is configured to use (or configured with) re-evaluation and/or pre-emption;

the resource pool for transmitting sidelink signal/channel is configured to enable re-evaluation and/or pre-emption;

the first UE is configured to use (or configured with) the resource allocation scheme;

the first UE is configured to enable the resource allocation scheme for re-evaluation and/or pre-emption;

the priority corresponding to the sidelink signal/channel is within a specific threshold range;

the latency corresponding to the sidelink signal/channel is within a specific threshold range; wherein the latency can be determined by PDB;

the battery remaining of the first UE is within a specific threshold range;

the congestion level of the resource pool is within a specific threshold range; wherein the congestion level can be determined by CBR;

whether the HARQ is enabled when the first UE transmits the sidelink signal/channel;

the HARQ error rate of the first UE is within a specific threshold range; wherein the HARQ error rate can be the HARQ error rate corresponding to the data carried by the sidelink signal/channel; wherein the HARQ error rate includes the probability of HARQ transmission failure within a period of time, and/or the number of HARQ (continuous) transmission failure; the HARQ transmission may be HARQ transmission corresponding to the data carried by the sidelink signal/channel that the first UE needs to transmit, or any HARQ-based transmission;

the number of retransmissions corresponding to the data carried by sidelink signal/channel that the first UE needs to transmit is within a specific threshold range;

whether the first node can expect the arrival time point of the sidelink signal/channel that needs to be transmitted, including whether the higher layer of the first UE indicates the resource reservation information (for example, the reservation period) corresponding to the sidelink signal/channel that needs to be transmitted in the previous transmission.

Wherein the resource allocation scheme includes at least one of the following: full sensing, partial sensing, random selection, re-evaluation and pre-emption. Wherein, the partial sensing may include partial sensing based on periodic sensing and/or partial sensing based on continuous sensing. Wherein, the full sensing and/or the partial sensing can include sensing before and/or after the data arrives at the physical layer and/or the higher layer triggers the physical layer to start the resource selection process (or start the sensing process, which can be similarly replaced in other parts in the full text of the specification and will not be repeated).

The main advantage of this method is that different resource allocation schemes may be applicable in different scenarios. For example, the sensing before the physical layer is triggered by the higher layer to enable the resource selection process requires the UE to be able to expect the time point when the higher layer triggers the physical layer to enable the resource selection process so that it can perform sensing before it is triggered, for another example, any sensing requires the UE to have sufficient sensing results before performing resource selection, while random selection does not have this requirement. Introducing appropriate conditions can enable the UE to select a more appropriate resource allocation scheme, and try to improve transmission performance and reduce power consumption on the premise of ensuring the resource allocation scheme.

In some implementations, the first UE determines a sensing window corresponding to the resource reselection including determining at least one of sensing window of periodic-based partial sensing and sensing window of contiguous partial sensing.

The sensing window of periodic-based partial sensing and or the sensing window of contiguous partial sensing further include at least one of following: the sensing window before the time point when the UE is triggered to select the resource, the sensing window after the time point when the UE is triggered to select the resource, and the sensing window from the time point when the UE is triggered to select the resource to before the UE selects the selected resource for the first time. Wherein the sensing window from the time point when the UE is triggered to select the resource to the resource selected by the UE for the first time may be limited by the processing latency of the UE, for example, assuming that the time point when the UE is triggered to select the resource is time slot n, the resource selected by the UE for the first time is in time slot n1, the time window can be [n+proc1, n1−proc2], wherein proc1 and proc2 correspond to the processing latency of the UE.

In some implementations, the first UE selects the determined type of sensing window corresponding to resource reselection based on at least one of the following:

the sensing type corresponding the resource reselection configured to the first UE;

the sensing type corresponding the resource reselection configured to the resource pool;

whether the first UE can expect the arrival time point of the sidelink signal/channel that needs to be transmitted, including whether the higher layer of the first UE indicates the resource reservation information (for example, the reservation period) corresponding to the sidelink signal/channel that needs to be transmitted in the previous transmission.

whether the cross-period resource reservation is allowed in the resource pool, for example whether the parameter sl-MultiReserveResource in the resource pool is configured to be enabled;

whether (only) periodic traffic is transmitted in the resource pool, and/or whether (only) aperiodic traffic is transmitted in the resource pool; for example, when only periodic traffic is transmitted in the resource pool, the type of the sensing window selected by the first UE includes the sensing window of period-based partial sensing; for another example, when aperiodic traffic is not transmitted in the resource pool, the type of the sensing window selected by the first UE does not include the sensing window of contiguous partial sensing.

In some implementations, when the first UE needs to transmit sidelink signal/channel to the second UE, it determines the sensing window of period-based partial sensing corresponding to resource reselection, including: determining the resources that can be used for re-evaluation and/or pre-emption, and determining the sensing window of period-based partial sensing corresponding to the resource or a subset of the resource.

In some implementations, when the first UE needs to transmit sidelink signal/channel to the second UE, it determines the sensing window of contiguous partial sensing corresponding to resource reselection, including: determining the resources that can be used for re-evaluation and/or pre-emption, and determining the sensing window of contiguous partial sensing corresponding to the resource or a subset of the resource.

Alternatively, determining the resource that can be used for re-evaluation and/or pre-emption includes determining based on at least one of the following:

the resource exists after the first UE is triggered to perform the resource selection; alternatively, considering the impact of the UE processing latency, for example, if the first UE is triggered to select a resource in time slot n, the resource exists after time slot n+proc3, wherein proc3 corresponds to the UE processing latency;

the resource exists before the maximum latency of the sidelink signal/channel that needs to be transmitted by the first UE; alternatively, for the sidelink signal/channel that needs to be transmitted by the first UE, the maximum allowable latency is multiplexed with the maximum latency in the transmission parameters of the last or last period of the data message carried by the sidelink signal/channel; wherein the maximum latency can be determined by remaining PDB; alternatively, if the first UE needs to determine Y candidate resources during the resource selection process, the resource should allow the no less than Y candidate resources that can be used for resource reselection existing during the resource reselection process of the first UE, for example, if the first UE is triggered to perform resource selection in time slot n and the remaining PDB corresponding to the resource selection is m, the resources exist after time slot n+m−Y/x, where x is the maximum number of candidate resources that may be included in each time slot;

the earliest and/or the latest several resources/time slots in the range of the resource that can be used for re-evaluation and/or pre-emption; for example, the UE determines that the resources exist after the resource selection triggered by the first UE and before the maximum delay allowed by the sidelink signal/channel that needs to be transmitted by the first UE, that is [n+proc3, n+m−Y/x], the resources are determined as the earliest a resources/b time slots in [n+proc3, n+m−Y/x];

a threshold range of the number of the resources or the length of time domain; for example, the number of the resources does not exceed a, or the total length of the time domain does not exceed b time slots, where a and/or b can be (pre-)configured or predetermined, and can be specific to priority or other transmission parameters;

the resources may not be used as in a selection window or as a candidate resource by the first node in the resource selection process; for example, in Release 16, when the UE is triggered to perform resource selection in time slot n, the determined selection window is [n+T₁, n+T₂], where the upper bound and lower bound of T₁ is determined by 0≤T₁≤T_{proc,1}^{SL}, where T_{proc,1}^{SL} is (pre-)configured or a fixed parameter, therefore the latest possible start point of the selection window is n+T_{proc,1}^{SL}, the UE assumes that the resources between time slot n to n+T_{proc,1}^{SL} may not be used by the first UE as a selection window in the resource selection process or as resources for candidate resources.

Alternatively, the resources existing after the first UE is triggered to perform resource selection include the resources existing in a specific time range and/or after a specific time range after the first UE is triggered to perform resource selection. Wherein the specific time range can be determined based on at least one of the following:

the UE selects the time range of the candidate sidelink resources (for example, candidate time slots or candidate single time slot resource). For this method, a specific example is when the UE is triggered to perform resource selection in time slot n, it determines candidate sidelink resources in the selection window[n+T₁, n+T₂], where the upper bound/lower bound of T₁ is determined by 0≤T₁≤T_{proc,1}^{SL}, then UE determines that the resources can be used for re-evaluation and/or pre-emption existing after n+T_{proc,1}^{SL} or after n+T₁ according to n+T_{proc,1}^{SL} or n+T₁;

the position relationship between the resources used for transmission determined by the UE includes the minimum and/or maximum offset between the resources. Wherein the determined resources for transmission include the resources determined by the initial resource selection process and/or the resources determined by the resource reselection. Wherein the maximum offset between resources includes the maximum range of the time domain span of the selected resources, which does not exceed 32 time slots in the existing techniques (in view of the fact that the current time slot of the transmission is also included, the maximum offset in the existing techniques can be 32-1, that is, 31 time slots). Wherein the minimum offset between resources includes the minimum time domain interval between two adjacent transmissions/retransmissions. The interval in the existing system is mainly used for the receiver UE to decode the received data and provide HARQ-ACK feedback, therefore, alternatively, only when HARQ is enabled (enabled in the resource pool and/or enabled by the UE for the transmission corresponding to the resource), and/or only for two adjacent transmissions/retransmissions of the same HARQ process, the specific time range is determined based on the minimum offset. Wherein adjacent transmissions/retransmissions include logically adjacent transmissions/retransmissions, for example, the first retransmission and the second retransmission of the same TB, which are not required to be adjacent physically. For this method, a specific example is that the first resource determined by the UE for transmission exists in subframe n+T′, and the minimum offset between resources is Z, thus the second resource determined by the UE for transmission is not before n+T′+Z, that is the resource can be used for re-evaluation and/or pre-emption exists after n+T′+Z;

the processing time or processing time range for the UE to perform the initial resource selection and/or resource reselection; for this method, a specific example is that the maximum processing time for the UE to perform initial resource selection is T_{proc,ini} the UE completes the initial resource selection no later than time slot n+T_{proc,ini} when it is triggered to perform resource selection in time slot n, then the resource can be used for re-evaluation and/or pre-emption exists after time slot n+ T_{proc,ini}.

Alternatively, for any one or more of the given resources in the resources or the subset of the resources, the UE adopts a method similar to determining the sensing window of the period-based partial sensing corresponding to the candidate resources in the resource selection window in the resource selection process, to determine the sensing window of the period-based partial sensing corresponding to the given resource. Alternatively, the UE determines that the intersection of the sensing window of the period-based partial sensing corresponding to each resource in the resources or the subset of the resources is the sensing window of the period-based partial sensing corresponding to the resource reselection.

Alternatively, for any one or more of the given resources in the resources or the subset of the resources, the UE adopts a method similar to determining the sensing window of the contiguous partial sensing corresponding to the candidate resource in the resource selection window in the resource selection process to determine the sensing window of the contiguous partial sensing corresponding to the given resource. Alternatively, for any one or more of the given resources in the resources or the subset of the resources, the UE determines that the sensing window of the contiguous partial sensing corresponding to the given resource is [m−x, m−proc4] when the resource is on time slot m, where x is (pre-) configured or predetermined, for example, determining x=32-1 according to the time domain span of the resources reserved by the SCI in Release 16, the maximum is 32 time slots (−1 is because 32 time slots include the current timeslot of the SCI); proc4 corresponds to the UE processing latency.

Alternatively, the UE determines that the intersection of the sensing window of the contiguous partial sensing corresponding to each resource in the resources or the subset of the resources is the sensing window of the contiguous partial sensing corresponding to the resource reselection. Alternatively, the UE determines that the start position of the sensing window of the contiguous partial sensing corresponding to the resource reselection is the starting position of the sensing window of the contiguous partial sensing corresponding to the earliest resource in the resources or the subset of the resources; and/or, determines that the end position of the sensing window of the continuous part corresponding to the resource reselection as the start position or end position of the resource or a subset of the resource (it can be limited by UE processing latency, for example, the start position of the resource or a subset of the resource is m′, then the end position of the sensing window of the contiguous partial sensing corresponding to the resource reselection is m′−proc5, where proc5 is the processing latency of the UE).

In some implementations, when the first UE needs to transmit a sidelink signal/channel to the second UE, it performs sensing on the sensing window corresponding to the initial resource selection, and performs sensing on the sensing window corresponding to resource reselection; then the sensing window corresponding to the sidelink signal/channel determined by the first UE is the union of the both, or the sensing window corresponding to the sidelink signal/channel determined by the first UE includes the sensing window corresponding to the initial resource selection or sensing window corresponding to the resource reselection (further, corresponding to the re-evaluation and/or pre-emption, which can be similarly replaced in other parts in the full text of the specification and will not be repeated). In some implementations, when the first UE needs to transmit a sidelink signal/channel to the second UE, it performs sensing on the sensing window corresponding to the initial resource selection, and performs sensing on the sensing window corresponding to resource reselection; then the sensing window corresponding to the sidelink signal/channel determined by the first UE includes the above two sub-windows, or the first UE determines the above two sensing windows respectively and performs sensing on each of the determined sensing windows.

Since the sensing results are used for the UE to perform resource selection, the sensing process should be completed before the UE actually determines the resource for transmission. For the initial resource selection, the time point when the UE actually determines the resource for transmission may be the time point when the UE is triggered to perform resource selection (for example, in the time slot where the UE is triggered to perform resource selection), or it may be before the candidate resource set determined by the UE (it can be before the earliest resource in the set). This time point may also be limited by the processing latency, for example, if the UE is triggered to perform resource selection in time slot n or the earliest resource in the candidate set selected by the UE is in time slot n1, the UE actually determines the resource used for transmission in time slot m, where m=n−proc6 or m=n1−proc6, where proc6 is the processing latency of the UE. Correspondingly, the sensing process needs to be completed before the time when the UE is triggered to perform resource selection, or before the candidate resource set determined by the UE, that is, the end time point of the sensing window needs to be earlier than the time point when the UE is triggered to perform resource selection or the candidate resource set determined by the UE. For the resource reselection, the end time point of the sensing window needs to be earlier than the transmission resource actually selected by the UE in the previous resource selection process.

Alternatively, earlier than the specific time point can be embodied through the boundary of the set, for example, when the UE is triggered to perform resource selection at time slot n, the sensing window is [, n−proc6), where the first half of the brackets is empty, which means no restriction, and the parentheses mean that n-proc6 is not included in the set.

In a specific example, the UE is triggered to perform resource selection in time slot n, and actually determines the resource for transmission in time slot m, and the determined at least one resource for transmission is on time slot m1. The end time point of the sensing window determined by the UE corresponding to the initial resource selection is earlier than time slot n (or n−proc6), or earlier than time slot m (or m−proc6). The start time point of the sensing window determined by the UE corresponding to the resource reselection is not earlier than the time slot m, and the end time point is earlier than the time slot m1 (or m1−proc6). Alternatively, the UE decides whether it is necessary to determine the sensing window corresponding to the resource reselection and perform sensing on it according to whether it is configured to enable re-evaluation and/or pre-emption.

Alternatively, when the sensing window corresponding to the initial resource selection includes a sensing window of the period-based partial sensing, for any candidate resource in the candidate resource set, when the resource is on the time slot t, its corresponding sensing window includes multiple discrete time slots t-Preserve*k, where Preserve corresponding to the resource reservation period in the resource pool, k is (pre-) configured or predetermined, and t-Preserve*k is before time slot n (or n-proc6) or before time slot m (or m-proc6). Further, the UE starts to calculate t-Preserve*k corresponding to each value k from time slot t, if the t-Preserve*k, which determined by the UE based on the (pre-) configured or predetermined value is not before time slot n (or n-proc6) or not before time slot m (or m-proc6), the UE considers the t-Preserve*k is not included in the sensing window; or the UE starts to calculate t-Preserve*k corresponding to each value k from time slot n (or n-proc6) or time slot m (or m-proc6). In a specific example, when k=x, t-Preserve*k is before time slot n (or n-proc6) or before time slot m (or m-proc6), the latest x time slots correspond to the time slots of t-Preserve*k′, and k′ is a positive integer. Alternatively, when the sensing window corresponding to the resource reselection includes a sensing window of the period-based partial sensing, for any candidate resource in the candidate resource set, when the resource is on the time slot t, its corresponding sensing window includes multiple discrete time slots t-Preserve*k, and t-Preserve*k is before time slot m1 (or m1−proc6) and after time slot m, the specific determination method is similar to that in the initial resource selection. In this method, when Preserve is relatively large, it is possible that the minimum value of k cannot make t-Preserve*k not before time slot m, in this scenario, it can be considered that the sensing window corresponding to resource reselection does not actually include the sensing window of the period-based partial sensing. Alternatively, the sensing window corresponding to the resource reselection can include the sensing window before time slot m, the advantage of this limitation is that if the UE has already performed sensing on some of the resources in the sensing window corresponding to the resource reselection prior to the time slot m before the actually determining the resource for transmission (it can be for other purposes, for example, the sensing on the first resource determination or the sensing on the transmission of other TBs), the sensing results can be used for resource reselection process.

Alternatively, when the sensing window corresponding to the initial resource selection includes a sensing window of the continuous sensing, for any candidate resource in the candidate resource set or the earliest candidate resource, when the resource is on the time slot t, its corresponding sensing window includes multiple continuous time slots [t−31, t−1] (or [t−31,t), a method similar to the other examples above can be used to add processing latency restrictions), and the end position of the sensing window is before time slot n (or n−proc6) or before time slot m (or m−proc6). Taking the end position of the sensing window before the time slot n as an example, the mathematical expression of the sensing window can be [t−31, min(t−1, n)]. Alternatively, when the sensing window corresponding to the resource reselection includes a sensing window of the continuous sensing, for any candidate resource in the candidate resource set or the earliest candidate resource, when the resource is on the time slot t, its corresponding sensing window includes multiple continuous time slots [t−31, t−1], and the start position of the sensing window is after time slot m and the end point of the sensing window is before time slot m1 (or m1−proc6). For example, the mathematical expression of the sensing window can be [max(t−31, m1), min(t−1, m1)].

In another specific example, the UE is triggered to perform resource selection in time slot n, and actually determines the resource for transmission in time slot m, and the determined at least one resource for transmission is on time slot m1. When the UE is configured to disable re-evaluation and/or pre-emption, the determined end time point of the sensing window is before time slot n (or n-proc6) or before time slot m (or m−proc6); When the UE is configured to enable re-evaluation and/or pre-emption, the determined end time point of the sensing window is before the time slot m1 (or m1−proc6).

Alternatively, when the sensing window determined by the UE includes a sensing window of the period-based partial sensing, for any candidate resource in the candidate resource set, when the resource is on the time slot t, its corresponding sensing window includes multiple discrete time slots t-Preserve*k, where Preserve corresponding to the resource reservation period in the resource pool, k is (pre-) configured or predetermined; and based on the UE is configured to enable/disable re-evaluation and/or pre-emption, t-Preserve*k is before time slot n (or n−proc6) or before time slot m (or m−proc6), or t-Preserve*k is before time slot m1 (or m1−proc6). The specific method for determining t-Preserve*k is similar to the other examples above, and the description will not be repeated.

Alternatively, when the sensing window determined by the UE includes a sensing window of the continuous sensing, for any candidate resource in the candidate resource set or the earliest candidate resource, when the resource is on the time slot t, its corresponding sensing window includes multiple continuous time slots [t−31, t−1] (or [t−31,t), a method similar to the other examples above can be used to add processing latency restrictions); and based on the UE is configured to enable/disable re-evaluation and/or pre-emption, the end position of the sensing window is before time slot n (or n−proc6) or before time slot m (or m−proc6), or t-Preserve*k is before time slot m1 (or m1−proc6). The specific method for determining the sensing window is similar to the other examples above, and the description will not be repeated.

In the sidelink communication system, the UE performs sensing on its own transmission and selects the transmission resource for its own transmission based on the sensing results is a typical channel sensing application scenario, such scenario is mainly used as an example in the above embodiments. In the sidelink communication system, there is another type of channel sensing application scenario, in which the UE performs sensing on the transmission of other UEs and transmits the sensing results to the other UEs to coordinate the other UEs in selecting transmission resources for the transmission of the other UEs. This application scenario may appear in a sidelink communication system that supports inter-UE coordination, the sensing results are used as the coordinate information between UEs, so that the transmitter UE can select transmission resources with better communication quality based on the channel interference condition on the receiver UE. The following takes such scenario as an example to illustrate some other communication methods that are feasible in the sidelink communication system.

In some implementation, a first UE performs channel sensing for a second UE, and the channel sensing is used to coordinate the second UE in determining the resources for the second UE to transmit sidelink signals/channels to the first UE and/or other nodes. In this implementation, the second UE can be replaced by other types of nodes, such as base station. The channel sensing for the second UE performed by the first UE includes the sensing corresponding initial resources selection and/or resource reselection, and includes the sensing for determining preferred resources and/or unpreferred resources (including conflicting/expected conflicting resources).

The first UE determines the sensing window corresponding to the channel sensing performed for the second UE including at least one of the following:

The first UE receives the signaling for requesting coordinate information from the second UE, according to the resource position used by the signaling, and/or the resource position that the second UE is expected to use for transmission indicated in the signaling, determines the sensing window. For example, the first UE receives the signaling for requesting coordinate information form the second UE in time slot t, the resource position that the second UE is expected to use for transmission indicated in the signaling is time slot [t1, t2], then the first UE determines that the start position of the sensing is not earlier than t+proc7 and/or the end position of the sensing window is not later than t1−proc8, where t+proc7 and t−proc8 correspond to processing latency;

The first UE determines the sensing window according to the resource position used by the first UE to transmit coordinate information to the second UE. For example, the first UE determines to transmit coordinate information to the second UE in the time slot t, and the end position of the sensing window corresponding to the sensing carried in the coordinate information is no later than t−proc8, where t−proc8 corresponds to processing latency. Alternatively, the resource position used by the first UE to transmit coordinate information to the second UE is determined based on the resource position that the second UE is expected to use for transmission, for example, the second UE indicates in the signaling for requesting coordinate information that the resource position that the second UE is expected to use for transmission is the time slot [t1, t2], then the first UE determines that the time slot range for transmitting coordinate information to the second UE is [t2−a, t1−b], alternatively, a corresponds to validity period of the coordinate information and b corresponds to processing latency, for example, the second UE receives the coordinate information and determines the processing latency of the resource position for transmission according to the content of the coordinate information; in this example, the end position of the sensing window is no later than t2−a−proc8;

the first UE determines the sensing window according to the sensing range indicated by the second UE, for example, performs sensing within the indicated range;

the first UE determines the sensing window corresponding to each resource according to the transmission resource indicated by the second UE; Including multiplexing the method of determining the corresponding sensing window according to the candidate sidelink resource of the first UE itself, and determining the sensing window corresponding to each transmission resource of the second UE. Wherein the transmission resource may be a transmission resource indicated or reserved by the second UE in the SCI.

In the above example, the first UE performs channel sensing for the second UE, and carries the results of the channel sensing in the coordinate information to indicate the second UE. Correspondingly, the second UE receives the coordinate information from the first UE, and according to the coordinate information, after selecting the transmission resource for the first time, it can also perform re-evaluation and/or pre-emption, the reselection triggered based on the detected conflict is used for transmitting the resource of sidelink signal/channel. Similar to the above-mentioned embodiments, this process can be referred as resource reselection for short.

In some implementations, the second UE receives the coordinate information from the first UE, and according to the coordinate information, after selecting a transmission resource for the first time, the resource reselection is triggered when at least one of the following conditions or a specific combination is satisfied:

the resource pool for transmitting sidelink signal/channel is configured to enable re-evaluation and/or pre-emption;

the resource pool for transmitting sidelink signal/channel is configured to enable sensing and/or partial sensing;

the resource pool for transmitting sidelink signal/channel is configured to enable sensing corresponding to re-evaluation and/or pre-emption;

the second UE is configured to use re-evaluation and/or pre-emption;

the second UE is configured to use sensing and/or partial sensing;

the second UE is configured to enable sensing corresponding to re-evaluation and/or pre-emption;

the priority corresponding to the sidelink signal/channel is within a specific threshold range;

the latency corresponding to the sidelink signal/channel is within a specific threshold range; wherein the latency can be determined by PDB;

the battery remaining of the second UE is within a specific threshold range;

the congestion level of the resource pool is within a specific threshold range; wherein the congestion level can be determined by CBR;

whether the HARQ is enabled when the second UE transmits the sidelink signal/channel;

the HARQ error rate of the first UE is within a specific threshold range; wherein the HARQ error rate can be the HARQ error rate corresponding to the data carried by the sidelink signal/channel; wherein the HARQ error rate includes the probability of HARQ transmission failure within a period of time, and/or the number of HARQ (continuous) transmission failure; the HARQ transmission may be HARQ transmission corresponding to data carried by the sidelink signal/channel that the first UE needs to transmit, or any HARQ-based transmission;

the number of retransmissions corresponding to the data carried by sidelink signal/channel that the second UE needs to transmit is within a specific threshold range;

the coordinate message received is invalid; alternatively, during a specific transmission or within a specific time period before a specific transmission, the coordinate information received is invalid; for example, the second UE receives the coordinate information and determines three transmission resources, the coordinate information is valid at the first and the second transmission resources but invalid at the third transmission resource due to timeout, then the second UE can perform resource reselection for the third selected transmission resource;

the second UE detects that the transmission/reception of other nodes conflicts with the selected transmission resource; for example, the second UE receives the coordinate information and determines one transmission resource, and subsequently receives the SCI of the third UE, the transmission resource is reserved in the SCI, and the target ID indicated by the SCI of the third UE is the ID of the second UE, that is, the sidelink reception and sidelink transmission expected by the second UE conflicts, then the second UE can perform resource reselection for the selected transmission resource. Alternatively, the conflict in this method includes the conflict caused by the half-duplex restriction between the sidelink transmission/reception, as shown in the above example; further includes the conflict between sidelink transmission and uplink transmission/downlink reception. The former mainly considers that when uplink transmission and sidelink transmission in the existing system are scheduled in the same time slot, whether they can be transmitted simultaneously depends on the UE capability, the priority of uplink transmission and downlink transmission, and the configuration (such as threshold configuration) of the system for simultaneous uplink and sidelink transmission, therefore, there is a certain probability that they cannot be sent at the same time; Even if they can be transmitted simultaneously, due to the limitation of the maximum transmission power of the UE, the transmission power of uplink transmission and/or sidelink transmission may be reduced, which will affect the reliability of transmission accordingly; Therefore, the conflict between uplink transmission and sidelink transmission can be understood as a type of conflict, and triggering resource reselection based on this type of conflict is beneficial to system performance. The latter mainly considers that if the sidelink communication system is extended to the flexible time slots/symbols in the TDD system, since flexible time slots/symbols can be indicated by the base station for downlink or uplink transmission through SFI, the conflict is likely to occur, and the due to the restriction of half-duplex, simultaneously transmission cannot be implemented, therefore triggering resource reselection based on this type of conflict is also beneficial to system performance.

In some implementations, the second UE receives the coordinate information from the first UE, and according to the coordinate information, after selecting a transmission resource for the first time, a resource reselection is triggered, and the sensing window corresponding to the reselection is determined based on at least one of the following of:

any method for determining the sensing window used when the first UE transmits a sidelink signal/channel to the second UE in the above example;

the second UE receives the coordinate information from the first UE, determines the time range corresponding to the resource indicated in the coordinate information, and determines that the start position of the sensing window corresponding to the reselection is not earlier than the end position of the time range;

the second UE receives the coordinate information from the first UE, determines the validity period of the coordinate information, and determines that the starting position of the sensing window corresponding to the reselection is not earlier than the end of the validity period;

the second UE receives coordinate information from the first UE at a specific time and/or is expected to receive coordinate information from the first UE at a specific time, determines that the start position of the sensing window corresponding to the reselection is not earlier than the time when the coordinate information should be received;

the second UE transmits the signaling for requesting coordinate information to the first UE, and determines that the start position of the sensing window corresponding to the reselection is not earlier than the time when the signaling for requesting coordinate information is transmitted.

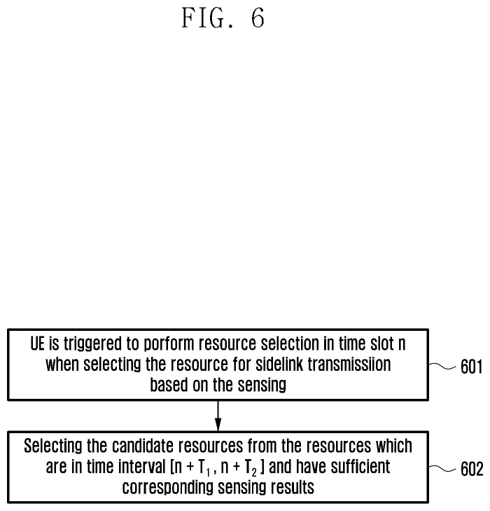

FIG. 6 schematically illustrates embodiment 2 according to an embodiment of the disclosure.

In the sidelink communication system, when the UE selects the resource for sidelink transmission based on the sensing, if resource selection is triggered in time slot n, the first UE selects candidate resource in time interval [n+T₁, n+T₂], wherein the value of T1 is limited by the processing latency, and the value of T2 is limited by T₂ₘᵢₙ determined based on the minimum value of the window configured by the higher layer and the remaining PDB of the delay parameter, in addition to those, the UE does not need to consider other restrictions on the selection of candidate resources.

For the sidelink communication system based on full sensing, since the UE can ensure that it has performed sensing in each previous time slot, no matter how the UE determines the candidate resource in [n+T₁, n+T₂], there will always be a sensing result corresponding to the candidate resource determined by the UE, using the above method will not affect the performance of the transmission. However, in the partial sensing system, since the UE may select a part of resources for sensing in advance instead of all resources according to the trigger state of the resource selection or the expectation of the trigger state, it may occur that some candidate resources in [n+T₁, n+T₂] are not sufficiently sensed. Therefore, for this potential problem, it is necessary to optimize the method for the UE to select candidate resources.

In some embodiments, as shown in FIG. 6, when the UE selects the resource for sidelink transmission based on the sensing, if the resource selection is triggered in time slot n (601), the first UE selects the candidate resources from the resources which are in time interval [n+T₁, n+T₂] and have sufficient corresponding sensing results (602).

Alternatively, the method for the UE to select candidate resources from resources with sufficient corresponding sensing results includes at least one of the following: a resource can be added to the candidate resource set at least when it has enough corresponding sensing results, otherwise it cannot be added to the candidate resource set; or the process of adding a resource to the candidate set by the UE is independent from whether the resource has sufficient corresponding sensing result, but after the candidate set is generated, for any resource in the candidate set, if the resource does not have sufficient corresponding sensing results, the resource is excluded from the candidate set.

In some implementations, the UE decides whether at least one resource has sufficient corresponding sensing results according to the following method: when the sensing window corresponding to the resource includes N time slots, if the UE performs sensing on no less than M of the N time slots, it is considered that the resource has sufficient corresponding sensing results, otherwise it does not have; wherein M is (pre-) configured or predetermined; wherein M can be determined by N, for example. M=N*x, where x is scaling factor, which is (pre-) configured or predetermined; M and x can be specific to priority or remaining PDB or other transmission parameters;

alternatively, when the UE selects resources for sidelink transmission based on sensing, it determines whether it has performed sensing in a time slot based on at least one of the following: the reception result on this time slot is buffered; sensing is performed by using the parameters of the sidelink transmission; sensing is performed by using other sidelink transmission parameters, and the offset between the other sidelink transmission parameters and the sidelink transmission parameters is within a specific threshold range.

In some implementations, the UE selects resources for sidelink transmission based on sensing, including selecting resources for the initial transmission of data and selecting resources for the retransmission of data. When the UE selects resources for data retransmission, it determines whether a new channel sensing (the sensing window of the channel sensing may be located after the time point when the UE is triggered to enable the resource selection process for transmission) can be performed based at least on the remaining PDB and/or the priority corresponding to the sidelink transmission, if the new channel sensing is allowed, the UE performs new channel sensing and selects resources and/or selects candidate resources based on the sensing results, otherwise it selects resources and/or selects candidate resources based on the current channel sensing results. Alternatively, when the remaining PDB is greater than the threshold, and/or the priority corresponding to the sidelink transmission is higher than the threshold (in fact, the priority value can be lower than the threshold value, because in the current technology, the smaller the value of the priority field of the physical layer, the higher the priority in the logical sense.), the UE determines that a new channel sensing can be performed, otherwise it cannot.

Alternatively, the UE can also determine how to select resources for the initial transmission of data and how to select resources for the retransmission of data based on whether HARQ is enabled for sidelink transmission. For example, when HARQ is not enabled, that is, retransmission is performed blindly, the UE selects resources for the initial transmission and subsequent retransmissions in one sensing; otherwise, when HARQ is enabled, the UE selects resources for at least the initial transmission in one sensing, and selects resources for data retransmission according to the above method.

In some implementations, if the number of resources which are in the time interval [n+T₁, n+T₂] and have sufficient corresponding sensing results is not within the specific threshold range (for example, when the UE needs to determine at least Y candidate resources in the resource selection process, the number of resources which are in the time interval [n+T₁, n+T₂] and have sufficient corresponding sensing results is less than Y), the UE performs at least one of the following:

determining the resources used for sidelink transmission without based on sensing;

determining the resources for sidelink transmission using other resource allocation schemes; for example, when the number of resources which are in the time interval [n+T₁, n+T₂] and have sufficient corresponding sensing results is not within the specific threshold range, contiguous partial sensing is used to determine the resource for sidelink transmission, and/or the random selection is used to determine the resource for sidelink transmission;

adjusting the threshold range, alternatively, adjusting based on the priority and/or other transmission parameters; for example, when the UE needs to determine at least Y candidate resources in the resource selection process, if the number of resources which are in the time interval [n+T₁, n+T₂] and have sufficient corresponding sensing results is less than Y, adjust Y as Y-Y′, where Y′ can be priority-specific;

adjusting the method for deciding whether at least one source has sufficient corresponding sensing results; for example, according to the method in the above example, when the sensing window corresponding to the resource includes N time slots, if the UE performs sensing on no less than M of the N time slots, it is considered that the resource has sufficient corresponding sensing results, otherwise it does not have; at this time, the value of M can be adjusted (including adjusting the value of x in the above method). In an specific example, if the number of resources which are in the time interval [n+T₁, n+T₂] and have sufficient corresponding sensing results is not within the specific threshold range, reduce the value of M to M′=M−m_step, if the number of resources with sufficient corresponding sensing results is still not within the specific threshold range after adjustment, continue to reduce the value of M′ to M″=M′−m_step; repeat this operation until the number of resources with sufficient corresponding sensing results is within a certain threshold range, or after repeating this operation several times, if the number of resources with sufficient corresponding sensing results is still not within the specified threshold range, use the other methods mentioned above, for example, use random selection to determine the resource for sidelink transmission.

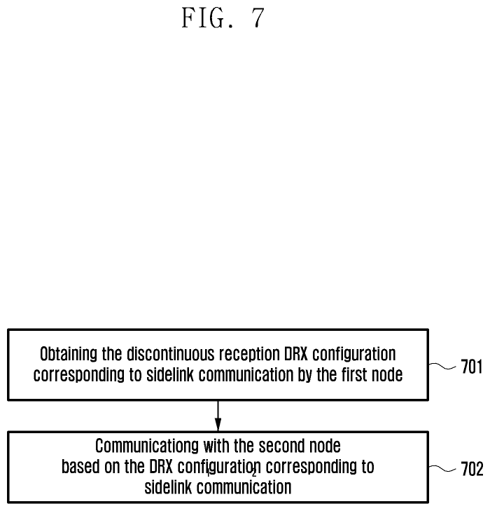

FIG. 7 schematically illustrates embodiment 3 according to an embodiment of the disclosure.

In the existing wireless communication system, the DRX mechanism is mainly used for the communication between the UE and the base station. Considering that the uplink and downlink transmission between the UE and the base station may be related to sidelink communication, for example, the DCI format transmitted by the base station to the UE for scheduling sidelink transmission, and the PUCCH and PUCCH transmitted by the UE to the base station for reporting PUCCH and/or UCI of sidelink HARQ-ACK feedback, the existing DRX mechanism needs to be optimized accordingly to cover the uplink and downlink transmissions related to sidelink communication and to coordinate work with the sidelink DRX mechanism. To be distinguished from sidelink DRX, in this embodiment, the DRX mechanism corresponding to uplink and downlink transmission is called Uu DRX.

Referring to FIG. 7, the first node obtains the discontinuous reception DRX configuration corresponding to the sidelink communication (701), and then communicates with the second node based on the DRX configuration corresponding to the sidelink communication (702), wherein the first node can be UE and the second node includes at least one of base station, sidelink node.

In some implementations, alternatively, a timer corresponding to the DCI format transmitted by the base station to the UE for scheduling sidelink transmission is introduced, the timer is included in Uu DRX configuration and/or sidelink DRX configuration, which is obtained by the UE through the RRC configuration and/or obtained from the resource pool configuration of the sidelink system. The main advantage of introducing this additional timer is that it considers the characteristics of the service corresponding to the interaction between the UE and gNB (referred to as Uu), such as the service period, the position and/or duration of the service burst in each period, etc., are likely to be different from the sidelink service, and it is more flexible to use an independent timer. In addition, when a timer is used to cover two types of services, since the active period corresponding to the timer needs to include the intersection of the active periods of the two types of services, based on the current indication method, the active period of the timer may also cover part of the time when neither of the two types of services are activated (For example, the active period of the Uu service is in the time slot [10, 20] (that is, the offset is 10, and the duration is 10), and the period is 100 time slots, and the active period of the sidelink service is in the time slot [30, 40], and the period is 200 time slots, then the most possible configuration of the timer is in time slot [10,40], and the period is 100 time slots), thereby causing additional consumption.

Alternatively, after receiving the DCI format for scheduling sidelink transmission, the UE starts or resets at least one Uu DRX timer, such as drx-InactivityTimer and/or the newly introduced timer, and/or starts or resets at least one sidelink DRX timer, such as SL-drx-InactivityTimer and/or the newly introduced timer. For example, during the active period of Uu DRX (including the time interval during which drx-InactivityTimer is running), if the UE receives the DCI format for scheduling sidelink transmission, it will start or reset a sidelink DRX timer. The main advantage of this method is that it can reuse the existing technology to treat the DCI format for scheduling sidelink transmission as a general downlink DCI, thereby affecting the duration of Uu DRX; it can also process the DCI corresponding to the sidelink and the DCI corresponding to the Uu separately, so that the reception of the DCI corresponding to the sidelink will not affect the active state of the Uu DRX. In addition, for some specific service scenarios, the sidelink DRX period configured by RRC can be set to be longer to save power consumption, and the sidelink timer can be dynamically started based on the DCI format of scheduled sidelink transmission received during the Uu DRX active period, which supports more flexible scheduling under the premise of low power consumption.

Alternatively, after receiving the DCI format for scheduling uplink and downlink transmission, the UE starts or resets at least one Uu DRX timer, such as drx-InactivityTime and/or the newly introduced timer, and/or starts or resets at least one sidelink DRX timer, such as SL-drx-InactivityTimer and/or the newly introduced timer. For example, during the active period of sidelink s DRX (including the time interval during which the SL-drx-InactivityTimer is running, and/or the time interval during which the newly introduced timer is running), if the UE receives a DCI format for scheduling uplink and downlink transmissions, it starts or resets a sidelink DRX timer, and/or starts or resets an uplink and downlink DRX timer. The main advantage of this method is similar to it of the method for the above-mentioned corresponding sidelink DCI starting/resetting Uu and sidelink DRX timer, it further includes the ability to schedule uplink and downlink transmissions during the active period of sidelink DRX, thereby making the base station scheduling mechanism more flexible; and based on the scheduling, the Uu DRX mechanism can be dynamically activated to ensure that subsequent possible uplink and downlink transmissions of the scheduling correspond to the Uu DRX active period, thereby ensuring the feasibility of the uplink and downlink transmissions.

Alternatively, for the sidelink DRX timer, if the DCI format schedules the initial transmission of data, the UE starts or resets the timer corresponding to the initial transmission, such as SL-drx-InactivityTimer; If the DCI format schedules data retransmission, the UE starts or resets the corresponding retransmission timer, such as SL HARQ retransmission timer. Alternatively, for the Uu DRX timer, regardless of whether the DCI format schedules initial transmission or retransmission of data, the at least one Uu DRX timer is started or reset.

In some implementations, alternatively, a timer corresponding to the PUCCH transmitted by the UE to the base station for reporting sidelink HARQ-ACK feedback is introduced, the timer is included in Uu DRX configuration and/or sidelink DRX configuration, which is obtained by the UE through the RRC configuration and/or obtained from the resource pool configuration of the sidelink system. Wherein the timer corresponds to PUCCH, but can also be used for UCI multiplexed on PUSCH or other uplink signals/channels, wherein the sidelink HARQ-ACK feedback can also be multiplexed on other uplink signals/channels. Alternatively, the length of the timer is different from the length of similar timers in the existing techniques, or is configured separately. In some other implementations, the length of at least one timer corresponding to PUCCH transmitted to the base station for reporting sidelink HARQ-ACK feedback and/or UCI is different from that in the existing techniques. Alternatively, the timer corresponding to the PUCCH and/or UCI transmitted by the UE to the base station for reporting sidelink HARQ-ACK feedback is multiplexed with the timer in the existing techniques, however, when the timer is started/reset due to the PUCCH transmitted by the UE to the base station for reporting sidelink HARQ-ACK feedback and/or UCI, the length of the timer takes the value corresponding to the sidelink; otherwise, when the timer is started/reset corresponding to other PUCCH and/or UCI in the uplink and downlink, the length of the timer takes the value in the existing techniques.

Alternatively, after transmitting the PUCCH for reporting sidelink HARQ-ACK feedback and/or UCI, the UE starts or resets at least one Uu DRX timer, such as drx-RetransmissionTimer and/or drx-HARQ-RTT-timer and/or the newly introduced timer, and/or starts or resets at least one sidelink DRX timer, such as drx-RetransmissionTimer and/or drx-HARQ-RTT-timer and/or the newly introduced timer, wherein the sidelink HARQ-ACK feedback can also be multiplexed on other uplink signals/channels.

Alternatively, only when at least one negative acknowledgement NACK is included in the reported sidelink HARQ-ACK feedback, the above start or reset behavior is performed. The advantage of this method is that in the sidelink system, NACK is usually reported to request the retransmission resources. If the content reported is all ACKs, the UE can assume that the base station will not schedule new DCI to indicate the retransmission resources on the sidelink, and the active period of DRX can be ended early to further reduce power consumption; otherwise, if at least one NACK is reported, the UE expects the base station to be able to schedule a new DCI to indicate the retransmission resources on the sidelink, at this time, it needs to start/reset the timer to extend the active period and receive the expected DCI.

Alternatively, when the sidelink HARQ-ACK feedback is expected to be reported but failed to be reported (for example, because the PUCCH conflicts with other uplink/downlink/sidelink transmissions and is dropped due to lower priority), the above-mentioned start or reset behavior is performed. Alternatively, when the downlink HARQ-ACK feedback is expected to be reported but fails to be reported (for example, because the downlink HARQ-ACK feedback conflicts with other UCI/PUSCH and is dropped), the above-mentioned start or reset behavior is performed. The advantage of this method is that if the UE fails to report the HARQ-ACK feedback, the base station may interpret the absence of the expected HARQ-ACK feedback as NACK, thereby a new DCI is transmitted to schedule the retransmission corresponding to the NACK, and the start/reset of the timer can extend the active period and receive the potential DCI.

In the existing techniques, the mode 1 sidelink transmission is the sidelink transmission scheduled by the base station, therefore, for mode 1, the DRX active period of the sidelink transmission may need to be aligned with the Uu DRX active period as much as possible, so that the UE is in the active state for a shorter time and can efficiently complete the reception and transmission of the uplink and downlink transmissions corresponding to the sidelink. In addition, because the sidelink transmission is often not expected or controlled by the base station (for example, when the UE at the other end of the sidelink transmission uses mode 2 or is controlled by another base station), the sidelink DRX configuration provided by the base station may not be suitable for the actual sidelink service state. Therefore, it is necessary to consider introducing a mechanism for the UE to request the base station to adjust the sidelink or Uu DRX configuration.

In some implementations, the UE can transmit to the base station, a signaling for requesting the base station, to perform at least one of the following: adjusting sidelink and/or Uu configuration, adding new sidelink and/or Uu configuration. The signaling can be at least one of RRC signaling, MAC signaling, UCI, PUSCH. Correspondingly, if the base station adjusts the sidelink and/or Uu DRX configuration, adds a new sidelink and/or DRX configuration, the adjustment can be indicated by RRC signaling (similar to the existing techniques), and/or by DCI. For the DCI indication, the indication may include all or part of the DRX information. For example, when only the offset of the DRX timer needs to be adjusted, the DCI only indicates the offset of the timer.

Alternatively, when at least one of the following conditions is satisfied, the UE transmits the signaling to the base station:

at least one sidelink transmission (for example, the data message arrives at the higher or physical layer of the UE, and is scheduled by the base station for sidelink transmission. for another example, the UE needs to transmit PSFCH to indicate the sidelink HARQ-ACK feedback information.) needs to be performed, and the resource position available for the at least one sidelink transmission is not within the inactive period of sidelink DRX;

at least one sidelink transmission needs to be performed, and the sensing window corresponding to the at least one sidelink transmission is not within the sidelink DRX active period; alternatively, this condition is only applied when the UE cannot perform sensing during the inactive period of sidelink DRX;

at least one sidelink transmission needs to be performed, and the uplink and downlink transmission/reception corresponding to the at least one sidelink transmission (including the DCI format for scheduling the sidelink transmission, the PUCCH for reporting the HARQ-ACK feedback corresponding to the sidelink transmission and/or UCI) is not within the active period of sidelink DRX and/or not within the active period of Uu DRX;

at least one sidelink reception (for example, the target ID indicated in the received SCI is the UE itself, and the UE needs to perform sidelink reception on all resources indicated in the SCI) needs to be performed, and the position of the at least one sidelink reception resource is not within the activation period of sidelink DRX.

The disclosure also discloses an electronic device, comprising: a memory, which is configured to store a computer program; and a processor, which is configured to read the computer program from the memory and run the computer program to implement the above method.

The term “module” may indicate a unit including one of hardware, software, firmware, or a combination thereof. The term “module” can be used interchangeably with the terms “unit”, “logic”, “logic block”, “component” and “circuit”. The term “module” may indicate the smallest unit or part of an integrated component. The term “module” may indicate the smallest unit or part that performs one or more functions. The term “module” refers to a device that can be implemented mechanically or electronically. For example, the term “module” may indicate a device including at least one of an application specific integrated circuit (ASIC), a field programmable gate array (FPGA), or a programmable logic array (PLA) that performs certain operations, which are known or will be developed in the future.

According to an embodiment of the present disclosure, at least a part of a device (for example, a module or its function) or a method (for example, an operation) may be implemented as instructions stored in a non-transitory computer-readable storage medium, for example, in the form of a programming circuit. When run by a processor, instructions can enable the processor to perform corresponding functions. The non-transitory computer-readable storage medium may be, for example, a memory.

Non-transitory computer-readable storage media may include hardware devices such as hard disks, floppy disks, and magnetic tapes (for example, magnetic tapes), optical media such as compact disk read-only memory (ROM) (CD-ROM) and digital versatile disk (DVD), magneto-optical media such as optical disks, ROM, random access memory (RAM), flash memory, etc. Examples of program commands may include not only machine language codes, but also higher layer language codes that can be executed by various computing devices using an interpreter. The aforementioned hardware devices may be configured to operate as one or more software modules to perform the embodiments of the present disclosure, and vice versa.

The circuit or programming circuit according to various embodiments of the disclosure may include at least one or more of the aforementioned components, omit some of them, or further include other additional components. Operations performed by the circuits, programming circuits, or other components according to various embodiments of the disclosure may be performed sequentially, simultaneously, repeatedly, or heuristically. In addition, some operations may be performed in a different order, or omitted, or include other additional operations.

While the disclosure has been shown and with reference to various embodiments thereof, it will be understood by those skilled in the art that various changes in form and details may be made therein without departing from the spirit and scope of the disclosure as defined by the appended claims and their equivalents.

What is claimed is:

1. A method for determining a sidelink resource, the method, performed by a first node, comprising:
enabling a power saving mechanism; and
determining a resource for sidelink transmission based on the power saving mechanism.

2. The method of claim 1, wherein the determining of the resource for sidelink transmission based on the power saving mechanism comprises:
performing resource selection corresponding to either re-evaluation or pre-emption or both of the re-evaluation and the pre-emption by the first node.

3. The method of claim 2,
wherein the resource selection comprises sensing-based resource selection, and
wherein the performing of the resource selection comprises:
determining a sensing window corresponding to the resource selection; and
performing sensing on the sensing window, in case that at least one of the following is satisfied:
the first node is configured to use either the re-evaluation or the pre-emption or both,
a resource pool for transmitting sidelink signal/channel is configured to enable either the re-evaluation or the pre-emption or both,
the first node is configured to use partial sensing,
the first node is configured to enable either the re-evaluation or the pre-emption or both corresponding to the sensing,
a priority corresponding to the sidelink signal/channel is within a specific threshold range,
a latency corresponding to the sidelink signal/channel is within a specific threshold range,
a battery remaining of the first node is within a specific threshold range,
a congestion level of the resource pool is within a specific threshold range,
whether a hybrid automatic repeat request (HARQ) is enabled when the first node transmits the sidelink signal/channel,
an HARQ error rate of the first node is within a specific threshold range, or
a number of retransmissions corresponding to data carried by sidelink signal/channel that the first node needs to transmit is within a specific threshold range.

4. The method of claim 2, further comprising:
in case that at least one of the following is satisfied, determining whether to use or not to use specific resource allocation schemes for resource selection:
the first node is configured to use either the re-evaluation or the pre-emption or both,
a resource pool for transmitting sidelink signal/channel is configured to either enable the re-evaluation or the pre-emption or both,
the first node is configured to use the resource allocation scheme,
the first node is configured to enable the resource allocation scheme for either the re-evaluation or the pre-emption or both,
a priority corresponding to the sidelink signal/channel is within a specific threshold range,
a latency corresponding to the sidelink signal/channel is within a specific threshold range,
a battery remaining of the first node is within a specific threshold range,
a congestion level of the resource pool is within a specific threshold range,
whether a hybrid automatic repeat request (HARQ) is enabled when the first node transmits the sidelink signal/channel,
an HARQ error rate of the first node is within a specific threshold range,
a number of retransmissions corresponding to data carried by sidelink signal/channel that the first node needs to transmit is within a specific threshold range, or
whether the first node can expect an arrival time point of the sidelink signal/channel that needs to be transmitted.

5. The method of claim 2,
wherein the resource selection comprises sensing-based resource selection,
wherein the performing of the resource selection comprises:
determining a sensing window; and
performing sensing on the sensing window, and
wherein the first node selects the determined sensing window corresponding to resource selection based on at least one of the following:
the sensing type corresponding to the resource selection configured to the first node,
the sensing type corresponding to the resource selection configured to a resource pool,
whether the first node can expect an arrival time point of sidelink signal/channel that needs to be transmitted,
whether a cross-period resource reservation is allowed in the resource pool, and
either whether periodic traffic is transmitted in the resource pool or whether aperiodic traffic is transmitted in the resource pool or both.

6. The method of claim 2, further comprising:
when the first node needs to transmit sidelink signal/channel to a second node, determining a sensing window of a period-based partial sensing corresponding to either the resource selection or the sensing window of a contiguous partial sensing corresponding to the resource selection or both,
wherein the determining of the sensing window comprises:
determining the resource that can be used for either the re-evaluation or the pre-emption or both; and
determining the sensing window of either the period-based partial sensing or the sensing window of contiguous partial sensing corresponding to the resource or a subset of the resource or both of the period-based partial sensing and the sensing window of the contiguous partial sensing corresponding to the resource or the subset of the resource, and
wherein the resource that can be used for either the re-evaluation or the pre-emption or both is determined based on at least one of the following:
the resource exists after the first node being triggered to perform the resource selection,
the resource exists before the maximum latency allowed by the sidelink signal/channel that the first node needs to transmit,
either the earliest or the latest several resources/time slots or both of the earliest and the latest several resources/time slots in a range of the resource that is to be used for either the re-evaluation or the pre-emption or both the re-evaluation and the pre-emption,
a threshold range of a number of the resources or a total length of time domain, or
the resource that is not to be used by the first node as in a selection window or as a candidate resource in a resource selection process.

7. The method of claim 2, further comprising:
in case that the resource selection is triggered in slot n, selecting candidate resources from resources which are in time interval [n+T₁, n+T₂] and have sufficient corresponding sensing results,
wherein the resource for sidelink transmission is determined based on the candidate resources.

8. The method of claim 7, wherein the first node decides whether at least one resource has sufficient corresponding sensing results based on the following:
when a sensing window corresponding to the resource includes N slots, in case that the first node performs sensing on no less than M slots of the N slots, identifying that the resource has sufficient corresponding sensing results.

9. The method of claim 7, further comprising:
in case that a number of the resources which are in time interval [n+T₁, n+T₂] and have sufficient corresponding sensing results is out of a specific threshold range, the first node performs at least one of the following:
determining the resource for sidelink transmission without based on the sensing;
determining the resource for sidelink transmission using other resource allocation schemes;
adjusting the threshold range; or
adjusting the method for deciding whether at least one resource has certain corresponding sensing results.

10. The method of claim 1, further comprising:
obtaining a discontinuous reception (DRX) configuration corresponding to a sidelink communication; and
communicating with a second node based on the DRX configuration corresponding to the sidelink communication.

11. The method of claim 10, further comprising:
enabling or resetting at least one DRX timer corresponding to uplink and downlink transmission or enabling or resetting at least one sidelink DRX timer after the first node receives either a downlink control information (DCI) format for scheduling sidelink transmission or the DCI format for scheduling uplink and downlink transmission or receives both of the DCI format for scheduling the sidelink transmission and the DCI format for scheduling the uplink and the downlink transmission; or
enabling or resetting the at least one DRX timer corresponding to the uplink and the downlink transmission and enabling or resetting the at least one sidelink DRX timer after the first node receives either the DCI format for scheduling the sidelink transmission or the DCI format for scheduling the uplink and the downlink transmission or receives both of the DCI format for scheduling the sidelink transmission and the DCI format for scheduling the uplink and the downlink transmission.

12. The method of claim 11, wherein enabling or resetting at least one sidelink DRX timer comprises:
in case that the DCI format schedules an initial transmission of data, the first node enables or resets a sidelink DRX timer corresponding to the initial transmission; and
in case that the DCI format schedules a retransmission of the data, the first node enables or resets a sidelink DRX timer corresponding to the retransmission.

13. The method of claim 10, wherein the first node transmits to the second node, a signaling for requesting the second node to perform at least one of the following:
either adjusting the sidelink DRX configuration or the DRX configuration corresponding to an uplink and downlink transmission or adjusting both of the sidelink DRX configuration and the DRX configuration corresponding to the uplink and downlink transmission, or
either adding new sidelink DRX configuration or the DRX configuration corresponding to the uplink and downlink transmission or adding both of the new sidelink DRX configuration and the DRX configuration corresponding to the uplink and downlink transmission.

14. A first node device comprising:
a memory configured to store a computer program; and
a processor coupled to the memory and configured to:
enable a power saving mechanism, and
determine a resource for sidelink transmission based on the power saving mechanism.

15. The first node device of claim 14, wherein the processor is further configured to:
perform resource selection corresponding to either re-evaluation or pre-emption or both of the re-evaluation and pre-emption by the first node.

16. The first node device of claim 15,
wherein the processor is further configured to:
in case that the resource selection is triggered in slot n, select candidate resources from resources which are in time interval [n+T₁, n+T₂] and have sufficient corresponding sensing results, and
wherein the resource for sidelink transmission is determined based on the candidate resources.

17. The first node device of claim 16, wherein the processor is further configured to decide whether at least one resource has sufficient corresponding sensing results based on the following:
when a sensing window corresponding to the resource includes N slots, in case that the first node device performs sensing on no less than M slots of the N slots, identify that the resource has sufficient corresponding sensing results.

18. The first node device of claim 14, wherein the processor is further configured to:
obtain a discontinuous reception (DRX) configuration corresponding to a sidelink communication, and
communicate with a second node based on the DRX configuration corresponding to the sidelink communication.

19. The first node device of claim 18, wherein the processor is further configured to:
enable or reset at least one DRX timer corresponding to uplink and downlink transmission or enable or reset at least one sidelink DRX timer after receiving either a downlink control information (DCI) format for scheduling sidelink transmission or the DCI format for scheduling uplink and downlink transmission or receive both of the DCI format for scheduling the sidelink transmission and the DCI format for scheduling the uplink and the downlink transmission, or
enable or reset the at least one DRX timer corresponding to the uplink and the downlink transmission and enable or reset the at least one sidelink DRX timer after receiving either the DCI format for scheduling the sidelink transmission or the DCI format for scheduling the uplink and the downlink transmission or receives both of the DCI format for scheduling the sidelink transmission and the DCI format for scheduling the uplink and the downlink transmission.

20. The first node device of claim 19, wherein the processor is further configured to:
in case that the DCI format schedules an initial transmission of data, enable or reset a sidelink DRX timer corresponding to the initial transmission, and
in case that the DCI format schedules a retransmission of the data, enable or reset a sidelink DRX timer corresponding to the retransmission.
